(19) United States
(12) Patent Application Publication
(10) Pub. No.: US 2003/0031501 A1
(43) Pub. Date: Feb. 13, 2003

(54) Applicator

(76) Inventor: Mark Ray Eadie, Queensland (AU)

Correspondence Address: HOFFMAN WASSON & GITLER, 2361 JEFFERSON DAVIS HIGHWAY, SUITE 522, ARLINGTON, VA, 22202

(21) Appl. No.: 10/182,707

(22) PCT Filed: Dec. 7, 2000
(86) PCT No.: PCT/AU00/01511

(30) Foreign Application Priority Data
Dec. 30, 1999 (AU) 65519/99

(51) Int. Cl. A46B 11/00; B43M 11/02

(52) U.S. Cl. 401/290; 401/270; 401/205

(57) ABSTRACT

An applicator (1) for applying a liquid stored in a container (10) to a work surface, said applicator comprising: an applicator portion (2); a catchment cup (3) connected to and fluidly communicating with the applicator portion (2); and a connector portion (4) connectable to and fluidly communicating with the container (10) and the catchment cup (3).

### FIELD OF THE INVENTION

The present invention relates generally to liquid applicators and, in particular, to liquid applicators connected to a bottle for applying a liquid contained in the bottle to a work surface.

The invention has been developed primarily for applying PVC priming fluid or PVC glue to PVC pipes and will be described hereinafter with reference to this application. However, it will be appreciated that the invention is not limited to this particular use.

### BACKGROUND ART

It is a well-known fact that large proportions of modem domestic plumbing systems use PVC (polyvinylchloride) pipes. A major advantage of PVC pipes over pipes constructed of other materials such as metal, is that PVC pipes are essentially corrosion resistant, inexpensive and relatively easy to work with. With regard to this last advantage, in order to interconnect pipes constructed of metal, a technique such as welding or soldering must be used. In contrast, appropriate glues can readily and reliably interconnect PVC pipes. It can be appreciated that, in most cases, gluing pipes together is simpler, less time consuming and less expensive than previous methods.

Current techniques for joining PVC pipes utilise a joining portion (also constructed of PVC) that connects an end of a first pipe to an end of a second pipe, in combination with PVC glue. The PVC glue has the effect of both hermetically sealing the joint and fixing the joining portion in position. However, before the PVC glue can be applied, the surfaces to which it is to be applied must be cleaned in order to achieve maximum adhesion between the glue and the surfaces to be glued. The cleaning process usually involves applying PVC priming fluid to the different surfaces.

Both PVC priming fluid and glue can be purchased in containers having a screw-top lid with an applicator brush attached thereto. The applicator brush is usually connected to the inner part of the lid so that the brush resides inside the bottle when the lid is attached to the bottle.

To apply the PVC priming fluid or glue, all that is required is to unscrew the lid and use the brush connected to the lid to apply the priming fluid or glue to the pipe surfaces in much the same manner as a painter would use a paint brush. Although such brush applicators are considered to be convenient and easy to use, they suffer from some deficiencies.

One such deficiency is that upon removing the lid and, hence, the brush from the bottle, it can be appreciated that if the bottle was to be knocked over in this state, the contents of the bottle are likely to spill out. Apart from causing annoyance, such an occurrence can be expensive not only because the contents of the bottle have been lost but also because the surface onto which the liquid spills may be irreparably damaged.

Another disadvantage of the prior art applicator is that the brush is usually completely submerged in the liquid. Thus, when the brush is removed from the bottle, it is necessary to wipe the excess liquid off the brush and onto the inner side of the bottle opening. More often than not, this results in some of the excess liquid spilling onto the outside of the bottle. If the person using the bottle does not wipe down the exterior of the bottle to remove such spillages, the spilled fluid will usually contact the skin of the person's hand when the person handles the bottle. This, of course, is an undesirable situation because PVC priming fluid and glue are toxic chemicals.

It is therefore desirable for an alternative means for applying PVC glue and priming fluid to be devised.

It is an object of the present invention to substantially overcome, or at least ameliorate, one or more of the deficiencies of the prior art.

### OBJECT OF THE INVENTION

It is an object of the present invention to substantially overcome, or at least ameliorate, one or more of the deficiencies of the prior art.

According to a first aspect of the present invention there is provided an applicator for applying a liquid stored in a container to a work surface, said applicator comprising:

an applicator portion;

a catchment cup connected to and fluidly communicating with the applicator portion; and

a connector portion connectable to and fluidly communicating with the container and the catchment cup.

Preferably, the applicator includes an adjustable flow control valve interposed between the catchment cup and the connector portion for regulating the flow of liquid between the container and the applicator.

The applicator portion can be constructed of a foam material or, alternatively, it can be a brush.

The connector portion can attach to the container in a manner similar to a traditional screw top.

### BRIEF DESCRIPTION OF THE DRAWINGS

Embodiments of the present invention will now be described with reference to the drawings in which:

FIG. 1 is a schematic diagram of an applicator according to a first embodiment of the present invention;

FIG. 2 is a schematic diagram of an applicator according to a second embodiment of the present invention;

FIG. 3 is a partial cross-sectional view of a portion of an applicator according to a third embodiment of the present invention;

FIG. 4 is a partial cross-sectional view of a portion of an applicator according to a fourth embodiment of the present invention; and

FIG. 5 illustrates the valve of the applicator of FIG. 4 in the open position.

### DETAILED DESCRIPTION

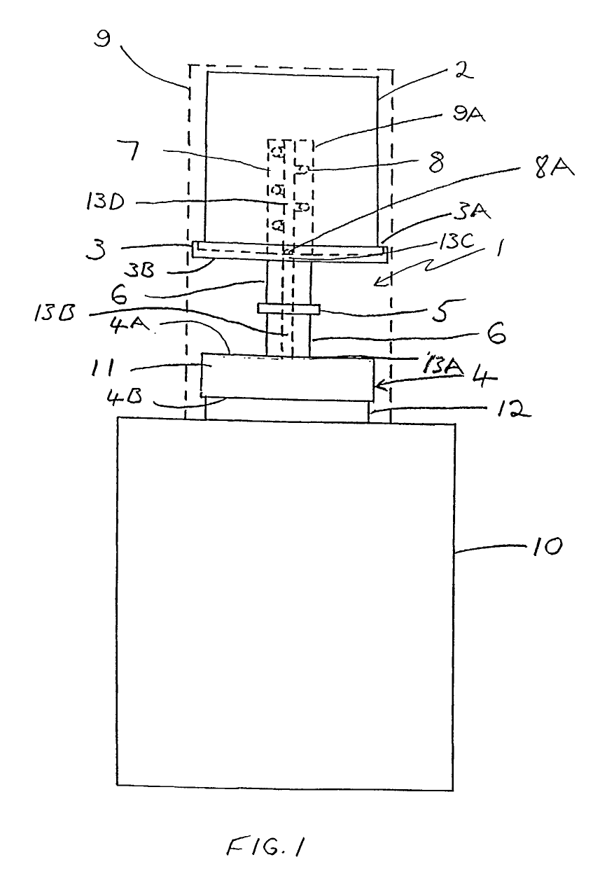

The general structure of an applicator 1 according to a first embodiment is illustrated in FIG. 1. The applicator 1 comprises a threaded connector portion 4 that is screwed onto a bottle 10. The connector 4 fluidly communicates with a catchment cup 3 via a neck portion 6. In turn, the catchment cup 3 fluidly communicates with a nozzle 7 having a plurality of nozzle holes 8. Attached to the nozzle 7 is an applicator portion in the form of a sponge 2.

The connector 4 comprises a cylindrical portion 11 that is partially closed at a first end 4A and open at a second end 4B. The inside of cylindrical portion 11 has a thread (not shown) that engages with a receiving thread (not shown) situated on the neck 12 of bottle 10. A hermetic seal results when connector 4 is attached to neck 12 of bottle 10.

Neck portion 6 comprises a hollow cylinder that has a first end integrally connected to connector 4. A hollow portion 13B of neck portion 6 communicates with a hollow portion 13A of connector 4 which, in turn, fluidly communicates with the interior of bottle 10 when connector 4 is attached to neck 12.

Catchment cup 3 is integrally connected to a second end of neck portion 6. The catchment cup 3 is cylindrical in shape and has a first end 3B that is completely closed except for a hollow portion 13C which fluidly communicates with hollow portion 13B. The end 3A of catchment cup 3 is open and defines a recess.

Nozzle 7 is cylindrical in shape and has a first end integrally connected to catchment cup 3. Nozzle 7 includes a hollow portion 13D that communicates with hollow portion 13C. Hollow portion 13D fluidly communicates with nozzle holes 8 located on the exterior of nozzle 7.

A cylindrical sponge 2 having a diameter greater than the diameter of nozzle 7 but less than the diameter of catchment cup 3 is attached to nozzle 7 via a hollow portion 9A having the same shape as nozzle 7 and which extends part way through the sponge 2. The sponge 2 is retained on nozzle 7 by interference fit between the hollow portion 9A and the exterior of the nozzle 7.

In order to control the flow of liquid between bottle 10 and nozzle 7, a flow control valve 5 connected to neck portion 6 is interposed between connector 4 and catchment cup 3. The flow control valve 5 enables the hollow portion 13B to be opened or closed. When in the open position, the flow control valve 5 allows liquid to travel between hollow portions 13A and 13C. When the flow control valve 5 is closed, liquid is prevented from flowing between hollow portions 13A and 13C. The flow control valve 5 can comprise any one of a number of sealable flow control valve types that are well known in the art.

A cap 9 having a first end engageable with connector 4 or bottle 10 is used to cover the applicator 1 when not in use.

The applicator 1 as previously described can be used to apply PVC glue or priming fluid contained in the bottle 10 by attaching the connector 4 of applicator 1 to the neck 12 of bottle 10 such that a hermetic seal is formed between connector 4 and the neck 12 of bottle 10.

The PVC glue or priming fluid contained in bottle 10 is applied to the sponge 2 of applicator 1 by squeezing the sides of bottle 10 (if bottle 10 is constructed of a flexible material) or upending the bottle 10 so that the glue or priming fluid flows towards the applicator 1. After the glue or priming fluid reaches the applicator 1 it flows into the hollow portions 13A, 13B, 13C and 13D. After reaching the nozzle 7, the glue or priming fluid is ejected out of nozzle holes 8. In this manner, the sponge 2 can be impregnated with the glue or priming fluid.

Upon sufficient glue or priming fluid being applied to the sponge 2 the user can cease squeezing the bottle or return the bottle from its upended position in order to stop the flow of glue or priming fluid between the bottle 10 and the sponge 2. The glue or priming fluid can then be applied to a work surface, such as a PVC pipe, by wiping the sponge on the surface of the pipe.

Note that in order for the glue or priming fluid to enter the nozzle 7 from the bottle 10, the flow control valve 5 must be in an open position.

As the PVC glue or priming fluid contained in the sponge 2 is transferred to the work surface, additional glue or priming fluid can be applied to the sponge 2 by again squeezing or upending the bottle 10. In this manner, the flow of glue or priming fluid to the sponge 2 can be easily regulated.

Excess glue or priming fluid contained in the sponge 2 flows down through the sponge 2 and into the recess 3A of catchment cup 3 when the bottle is placed in an upright position. The glue or priming fluid contained in the recess 3A then flows back into the bottle 10 (if the flow control valve 5 is in the open position) via a lowermost nozzle hole 8A in nozzle 7 and the hollow portions 13D, 13C, 13B and 13A. In this manner, undesirable spillage or wastage of priming fluid or glue is avoided.

When the applicator 1 is not in use, the flow control valve 5 can be closed so that glue or priming fluid cannot freely flow between the connector 4 and the nozzle 7. Also, the cap 9 can be placed on the applicator 1 in order to prevent the sponge 2, nozzle holes 8 or hollow portions 13A to 13D becoming clogged with dry priming fluid or glue.

In the event that the applicator 1 does become clogged with dry priming fluid or glue, the user can replace the applicator 1 by unscrewing it from the bottle 10 and replacing it with a new applicator 1. Alternatively, the user can remove the applicator 1 from the bottle 10 and clean the applicator 1 before re-attaching it to the bottle 10.

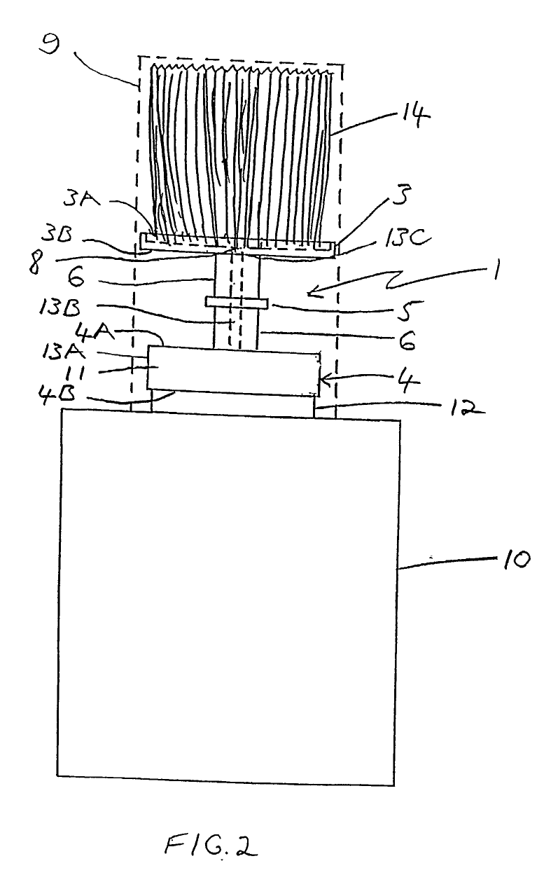

A second embodiment of the applicator 1 is illustrated in FIG. 2. The second embodiment of the applicator 1 is identical to the first embodiment previously described except that the sponge 2 of the first embodiment has been replaced by a brush 14 whose bristles are connected to the catchment cup 3. Also, the second embodiment does not have a nozzle 7 as liquid contained in the bottle 10 can be applied to the brush 14 by hollow portion 13C which communicates with the interior of bottle 10 by hollow portions 13B and 13A.

The operation of this second embodiment is similar to that of the first embodiment.

A third embodiment of the applicator 1 is illustrated in 3. In this embodiment, the flow control valve 5 consists of a stopper 21, collar 20 and an integrally formed nozzle/catchment cup 22.

The stopper 21 (which may for example be formed from plastic or rubber) consists of two concentric cylinders that are attached to each other so as to define an annular hollow through which fluid may pass. The outermost cylinder (not specifically indicated) has flanges (not specifically indicated) at both ends, and the inner cylinder (not specifically indicated) protrudes from one end of the outer cylinder. The stopper 21 is attached to the connector 4 by interference fit so as to form a seal between the stopper 21 and the connector 4. When the stopper 21 is attached to the connector 4, one of the flanges of the outermost cylinder abuts against an inner surface of the connector 4.

The collar 20 also consists of two concentric cylinders (not specifically indicated). The cylinders are integrally formed with each other and a web (not specifically indicated) interconnects one end of each cylinder. The inner cylinder is formed so that it can be attached to the stopper 21 by interference fit to form a seal between the inner cylinder of the collar 20 and the stopper 21. When mounted on the stopper 5, the collar 20 is oriented so that the web is adjacent the end of the stopper 5 that is furthest from the connector 4. Also, the collar 20 can slide up and down the stopper 21. Complementary flanges on both the inner surface of the inner cylinder of the collar 20 and the outer surface of the stopper 21 also provide a buffer function to prevent the collar 20 from being easily removed from the stopper 21.

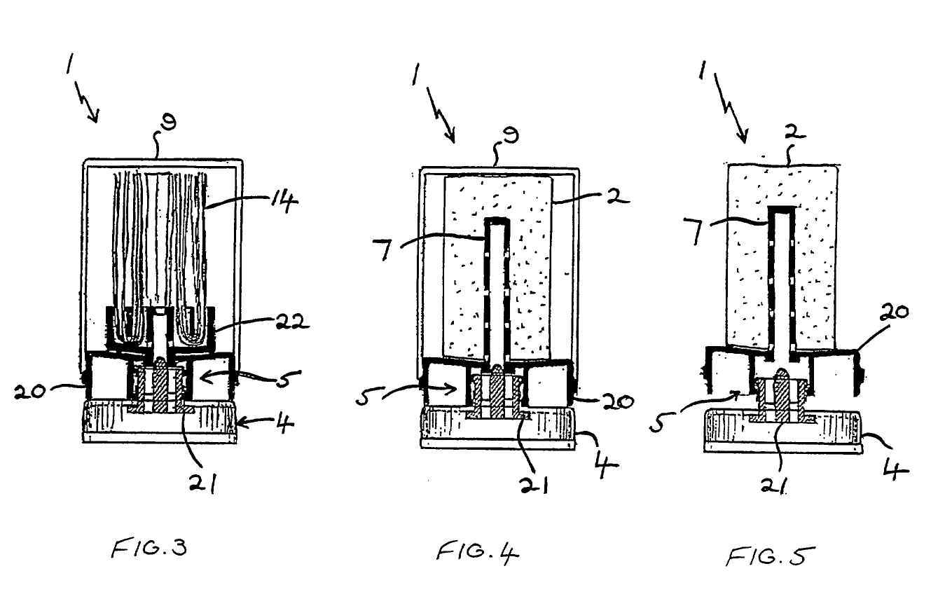

The nozzle/catchment cup 22 has a similar configuration to the nozzle 7 and catchment cup 3 of the applicator illustrated in FIG. 1. However, a lower portion of the nozzle (not specifically indicated) of the nozzle/catchment cup 22 illustrated in FIG. 3 protrudes through the bottom of the catchment cup (not-specifically indicated). This lower portion is formed so that the nozzle/catchment cup 22 can be attached to the collar 20 by interference fit so as to form a seal. The lower portion also seals the annular hollow in the stopper 21 when the collar 20 abuts against the connector 4. The protruding portion of the inner cylinder of the stopper 21 functions as a centreing mechanism so that the lower portion of the nozzle is correctly aligned with the annular hollow in the stopper 21.

Bristles 14 are also attached to the catchment cup portion of the nozzle/catchment cup 22.

A cap 9 having a first end engageable with the collar 20 is used to cover the applicator 1 when the applicator 1 is not in use.

FIG. 4 illustrates a fourth embodiment of the applicator 1. In this embodiment the flow control valve consists of a stopper 21 and a collar 20 in a similar manner to the applicator 1 illustrated in FIG. 3. However, the nozzle 7 is not integrally formed with a catchment cup. The nozzle 7 is attached directly to the collar 20 in a similar manner to that previously explained in relation to FIG. 3. With reference to FIG. 4, it can be seen that the web portion of the collar 20 that interconnects the inner and outer cylinders of the collar 20 slopes inwardly so as to form a catchment cup.

Similarly to the applicator 1 illustrated in FIG. 1, the applicator 1 illustrated in FIG. 4 has a cylindrical sponge 2 that is attached to the nozzle 7.

FIG. 5 illustrates the operation of the valve 5 of the applicator 1 illustrated in FIG. 4. It can be seen that sliding the collar 20 away from the connector 4 results in the annular hollow in the stopper 21 being opened so that fluid can travel through the stopper 21 and into the nozzle 7.

In order to prevent the collar 20 from being unintentionally removed from engagement with the stopper 21, the end of the stopper 21 that is furthest from the connector 4 has a flange around its periphery. Also, the inner cylinder of the collar 20 has a flange around the inner periphery of the end closest to the connector 4. Thus, if the collar 20 is moved away from the connector 4 so that the previously mentioned flanges of both the stopper 21 and collar 20 engage, this will impede the separation of the collar 20 from the connector 4.

The foregoing describes only some embodiments of the present invention and modifications, obvious to those skilled in the art, can be made thereto without department from the scope of the present invention.

It is to be understood that the term “comprising” as used herein is to be understood in the inclusive sense of “having” or “including” and not in the exclusive sense “consisting essentially of”.

1. An applicator for applying a liquid stored in a container to a work surface, said applicator comprising:
an applicator portion;
a catchment cup connected to and fluidly communicating with the applicator portion; and
a connector portion connectable to and fluidly communicating with the container and the catchment cup.

2. The applicator of claim 1 including an adjustable flow control valve interposed between the catchment cup and the connector portion for regulating the flow of liquid between the container and the applicator portion.

3. The applicator of claim 2, wherein the adjustable flow control valve includes a sealing member that is attached to the catchment cup and the connector portion, wherein the sealing member can be selectively moved relative to the container to operate the valve.

4. The applicator of any one of claims 1 to 3, wherein the applicator portion includes a sponge.

5. The applicator of claim 4, wherein the applicator portion includes a nozzle that is attached to the sponge and catchment cup and is in fluid communication with the sponge, catchment cup and the container.

6. The applicator of claim 5, wherein the nozzle includes at least one aperture that substantially enables fluid contained in the catchment cup to drain into the container.

7. The applicator of any one of claims 1 to 3, wherein the applicator portion includes a plurality of bristles.

8. The applicator of claim 7, wherein the applicator portion includes a nozzle that is attached to the catchment cup and is in fluid communication with the bristles, catchment cup and the container.

9. The applicator of claim 8, wherein the nozzle includes at least one aperture that substantially enables fluid contained in the catchment cup to drain into the container.

10. The applicator of any one of claims 1 to 3, including a cap for selectively covering at least part of the applicator.

11. The applicator of claim 4, including a cap for selectively covering at least part of the applicator.

12. The applicator of claim 5, including a cap for selectively covering at least part of the applicator.

13. The applicator of claim 6, including a cap for selectively covering at least part of the applicator.

14. The applicator of claim 7, including a cap for selectively covering at least part of the applicator.

15. The applicator of claim 8, including a cap for selectively covering at least part of the applicator.

16. The applicator of claim 9, including a cap for selectively covering at least part of the applicator
